(19) United States
(12) Patent Application Publication
(10) Pub. No.: US 2016/0340512 A1
(43) Pub. Date: Nov. 24, 2016

(54) Nanoparticle Powder Composition and Method of Making the Same

(71) Applicant: 3M INNOVATIVE PROPERTIES COMPANY, Saint Paul, MN (US)

(72) Inventor: Jimmie R. Baran, Jr., Prescott, WI (US)

(21) Appl. No.: 15/106,748

(22) PCT Filed: Dec. 17, 2014
(86) PCT No.: PCT/US2014/070922

§ 371 Date: Jun. 20, 2016

Related U.S. Application Data
(60) Provisional application No. 61/918,280, filed on Dec. 19, 2013.

(51) Int. Cl. C09C 1/30; B01J 20/22; C07F 7/18; B01J 20/02; B01F 17/54; C09K 5/14; B01J 20/04

(52) U.S. Cl. CPC C09C 1/3081; C09K 5/14; B01J 20/22; B01J 20/046; B01J 20/0288; B01J 20/0225; C09C 1/3009; C09C 1/309; B01F 17/0071; C07F 7/1836; C01P 2004/64

(57) ABSTRACT

Nanoparticle composition comprising hydrophobic, non-aggregate nanoparticles, an aqueous liquid, and gas, wherein the weight ratio of the hydrophobic, non-aggregated nanoparticles to the aqueous liquid in the nanoparticle powder composition is in a range from 1:1 to 1:99. Nanoparticle powder compositions described herein are useful, for example, for generating foams, delivering water as a dry raw material, as a material that serves as a heat sink.

### BACKGROUND

In general the use of hydrophobic fumed silica particles for making dry water is known. Fumed silica particles are known in the art to be aggregate particles, including aggregates of nanoparticles.

Alternative forms of dry water or the like are desired in the art.

### SUMMARY

In one aspect, the present disclosure describes a nanoparticle powder composition comprising hydrophobic, non-aggregated nanoparticles, an aqueous liquid, and gas (e.g., including at least one of N₂, CO₂, Ar, F₂, NH₃, H₂, or He, or even air), wherein the weight ratio of the hydrophobic, non-aggregated nanoparticles to the aqueous liquid in the nanoparticle powder composition is in a range from 1:1 to 1:99 (in some embodiments, in a range from 1:1 to 2.2: 97.8, 1:1 to 3:97, 1:1 to 4:96, 1:1 to 5:95, 1:1 to 10:90, 15: 1:1 to 85, 1:1 to 20:80, or even 1:1 to 25:75).

In another aspect, the present disclosure describes a method of making the nanoparticle powder composition described herein, the method comprising mixing under high shear at least hydrophobic, non-aggregated nanoparticles, an aqueous liquid, and gas (e.g., including at least one of N₂, CO₂, Ar, F₂, NH₃, H₂, or He, or even air), wherein the weight ratio of the hydrophobic, non-aggregated nanoparticles to the aqueous liquid in the nanoparticle powder composition is in a range from 1:1 to 1:99 (in some embodiments, in a range from 1:1 to 2.2: 97.8, 1:1 to 4:96, 1:1 to 5:95, 1:1 to 10:90, 1:1 to 15:85, 1:1 to 20:80, or even 1:1 to 25:75) to provide the nanoparticle powder composition.

In this application:

“nanoparticles” refer to particles having a diameter of less than 100 nm; although the particles can be agglomerated, but not aggregated.

“non-aggregated nanoparticles” refers to individual (discrete) particles or agglomerated particles not bonded together by at least one of covalent bonding, hydrogen bonding, or electrostatic attraction. Fumed silica particles are known in the art to be aggregate particles, including aggregates of nanoparticles. Therefore, fumed silica having a (aggregate) particle size of at least 100 nm, even if made up of silica nanoparticles, would not be non-aggregated nanoparticles.

Nanoparticle powder compositions described herein are useful, for example, for generating foams, delivering water as a dry raw material, or as a material that serves as a heat sink.

### BRIEF DESCRIPTION OF THE DRAWINGS

FIG. 1 is thermogravimetric analysis (TGA) trace of deionized water;

FIG. 2 is TGA trace of Example 1 powder; and

FIG. 3 is TGA trace of Example 9 powder.

### DETAILED DESCRIPTION

Nanoparticle powder compositions described herein can be made, for example, by a method comprising mixing under high shear at least hydrophobic, non-aggregated nanoparticles, an aqueous liquid, and gas, wherein the weight ratio of the hydrophobic, non-aggregated nanoparticles to the aqueous liquid in the nanoparticle powder composition is in a range from 1:1 to 1:99 (in some embodiments, in a range from 1:1 to 2.2: 97.8, 1:1 to 3:97, 1:1 to 4:96, 1:1 to 5:95, 1:1 to 10:90, 15: 1:1 to 85, 1:1 to 20:80, or even 1:1 to 25:75) to provide the nanoparticle powder composition.

In some embodiments, the aqueous liquid consists of water. In some embodiments, the aqueous liquid comprises water and at least organic liquid (e.g., an alcohol (e.g., methanol, ethanol, isopropanol, and butanol), ketones (e.g., acetone and methylethylketone), esters (e.g., methyl acetate), aldehydes (e.g., formaldehyde), and glycols (e.g., ethylene glycol), and glycol ethers (e.g., 2-butoxyethanol)). In some embodiments, the organic liquid is present in a range from greater than zero to 10 percent by weight (in some embodiments, in a range from greater than zero to 5 percent by weight), based on the total weight of the aqueous liquid.

Exemplary gasses include including at least one of N₂, CO₂, Ar, F₂, NH₃, H₂, or He, or even air;

In some embodiments, the nanoparticles comprise at least one of ceramic (e.g., glass, glass-ceramic, crystalline ceramic, and combinations thereof), or metal (including amorphous metal). In some embodiments, the nanoparticles comprise at least one of SiO₂, TiO₂, MgO, Al₂O₃, Fe₂O₃, ZnO, ZrO₂, rare earth oxides (e.g., CeO₂, Dy₂O₃, Er₂O₃, Eu₂O₃, Gd₂O₃, Ho₂O₃, La₂O₃, Lu₂O₃, Nd₂O₃, Pr₆O₁₁, Sm₂O₃, Tb₂O₃, Th₄O₇, Tm₂O₃, Yb₂O₃, and combinations thereof), CaCo₃, Ag, Al, or Ag.

In some embodiments, the nanoparticles have a primary particle size of not greater than 20 nm (in some embodiments, not greater than 15 nm, 10 nm, or even not greater than 5 nm; in some embodiments in a range from 4 nm to 20 nm; 4 nm to 15 nm, or even 4 nm to 10 nm).

Suitable nanoparticles include those made, for example, by reacting an alkoxysilane (i.e., monoalkoxy, diakoxy, or even trialkoxy silane) with a silica nanoparticle, or adsorbing an organic acid (e.g., acetic acid) or an organic base (e.g., triethylamine) onto, for example, a metal oxide nanoparticle or an organic thiol molecule onto gold nanoparticles.

In some embodiments, the weight ratio of the hydrophobic, non-aggregated nanoparticles to the aqueous liquid in the nanoparticle powder composition is in a range from 1:1 to 2.2: 97.8, 1:1 to 3:97, 1:1 to 4:96, 1:1 to 5:95, 1:1 to 10:90, 1:1 to 15:85, 1:1 to 20:80, or even 1:1 to 25:75).

In some embodiments, the nanoparticles are surface modified with a covalently bonded surface modifier. Examples of silanes include organosilanes (e.g., alkylchlorosilanes; alkoxysilanes (e.g., methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, butyltrimethoxysilane, butyltriethoxysilane, hexyltrimethoxysilane, octyltrimethoxysilane, 3-mercaptopropyltrimethoxysilane, n-octyltriethoxysilane, isooctyltrimethoxysilane, phenyltriethoxysilane, polytriethoxysilane, vinyltrimethoxysilane, vinyldimethylethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri(t-butoxy)silane, vinyltris(isobutoxy)silane, vinyltris(isopropenoxy)silane, and vinyltris(2-methoxyethoxy)silane; trialkoxyarylsilanes; isooctyltrimethoxy-silane; silane functional (meth)acrylates (e.g.,3-(methacryloyloxy)propyltrimethoxysilane, 3-acryloyloxypropyltrimethoxysilane, 3-(methacryloyloxy)propyltriethoxysilane, 3-(methacryloyloxy)propylmethyldimethoxysilane, 3-(acryloyloxypropyl)methyldimethoxysilane, 3-(methacryloyloxy)propyldimethylethoxysilane, 3-(methacryloyloxy)methyltriethoxysilane, 3-(methacryloyloxy)methyltrimethoxysilane, 3-(methacryloyloxy)propyldimethylethoxysilane, 3-(methacryloyloxy)propenyltrimethoxysilane, and 3-(methacryloyloxy)propyltrimethoxysilane))), and are commercially available from Gelest, Inc., Morrisville, Pa. For example, an organosilane (e.g., isooctyltrimethoxysilane) can be reacted with silica nanoparticles in an alcoholic aqueous dispersion by adding heat with stirring. In some embodiments, the nanoparticles comprise surface modified silica nanoparticles formed by reaction of silica nanoparticles with isooctyltrimethoxysilane.

Mixing of the components under high shear can be provided using conventional techniques (e.g., a common kitchen blender). In such high shear mixing, surrounding gas inherently is inherently incorporated into the resulting mix. When mixing in air, the gas is air. If other gas (e.g., N₂, CO₂, Ar, F₂, NH₃, H₂, or He) is desired to be incorporated into the resulting mix, blending can be conducted I the applicable gas atmosphere and/or be injected into the mixture during the high shear mixing.

In some embodiments, the aqueous liquid having a surface tension greater than 50 dynes/cm² at 25° C. (in some embodiments, greater than 55 dynes/cm², 60, 63, 65, or even greater than 70 dynes/cm² at 25° C.; in some embodiments up to 72 dynes/cm² at 25° C.; in some embodiments, in a range from 50 dynes/cm² to 72 dynes/cm², 55 dynes/cm² to 72 dynes/cm², 60 dynes/cm² to 72 dynes/cm², 63 dynes/cm² to 72 dynes/cm², or even 65 dynes/cm² to 72 dynes/cm² at 25° C.). The surface tension of the aqueous phase can be measured using common techniques such as the Wilhelmy plate or duNuoy ring methods.

In some embodiments, nanoparticle powder compositions described herein further comprise a surfactant. While typically nanoparticle powder compositions described here are free of a surfactant (i.e., contain less than 0.1 weight percent, based on the total weight of the nanoparticle powder composition), if a surfactant is present, typically it is not greater than 1 weight percent, based on the total weight of the nanoparticle powder composition. Exemplary surfactants include anionic surfactants (e.g., sodium lauryl sulfate, sodium dioctylsulfosuccinate, sodium oleate), cationic (e.g., dodecyltrimethylammonium bromide), nonionic (alkyl ethoxylates, alkylphenol ethoxylates), polymeric (e.g., ethylene oxide/propylene oxide block copolymers, and are commercially available from Sigma Aldrich, St. Louis, Mo.

Nanoparticle powder compositions described herein are useful, for example, for generating foams, delivering water as a dry raw material, as a material that serves as a heat sink.

### Exemplary Embodiments

A nanoparticle powder composition comprising hydrophobic, non-aggregated nanoparticles, an aqueous liquid, and gas (e.g., including at least one of N₂, CO₂, Ar, F₂, NH₃, H₂, or He, or even air); wherein the weight ratio of the hydrophobic, non-aggregated nanoparticles to the aqueous liquid in the nanoparticle powder composition is in a range from 1:1 to 1:99 (in some embodiments, in a range from 1:1 to 2.2: 97.8, 1:1 to 4:96, 1:1 to 5:95, 1:1 to 10:90, 1:1 to 15:85, 1:1 to 20:80, or even 1:1 to 25:75).

The nanoparticle powder composition of claim 1, wherein the aqueous liquid consists of water.

The nanoparticle powder composition of claim 1, wherein the aqueous liquid comprises water and at least organic liquid (e.g., an alcohol (e.g., methanol, ethanol, isopropanol, and butanol), ketones (e.g., acetone and methylethylketone), esters (e.g., methylacetate), aldehydes (e.g., formaldeyhde), and glycols (e.g., ethylene glycol), and glycol ethers (e.g., 2-butoxyethanol)).

The nanoparticle powder composition of claim 3, wherein the organic liquid is present in a range from greater than zero to 10 percent by weight (in some embodiments, in a range from greater than zero to 5 percent by weight), based on the total weight of the aqueous liquid.

The nanoparticle powder composition of any preceding claim, wherein the nanoparticles comprise at least one of glass, glass-ceramic, crystalline ceramic, or metal.

The nanoparticle powder composition of any preceding claim, wherein the nanoparticles comprise at least one of SiO₂, TiO₂, MgO, Al₂O₃, Fe₂O₃, ZnO, ZrO₂, rare earth oxides (e.g., CeO₂, Dy₂O₃, Er₂O₃, Eu₂O₃, Gd₂O₃, Ho₂O₃, La₂O₃, Lu₂O₃, Nd₂O₃, Pr₆O₁₁, Sm₂O₃, Tb₂O₃, Th₄O₇, Tm₂O₃, Yb₂O₃, and combinations thereof), CaCo₃, Ag, Al, or Ag.

The nanoparticle powder composition of any preceding claim, wherein the nanoparticles are surface modified with a covalently bonded surface modifier.

The nanoparticle powder composition of any preceding claim, wherein the nanoparticles have a primary particle size of not greater than 20 nm (in some embodiments, not greater than 15 nm, 10 nm, or even not greater than 5 nm; in some embodiments in a range from 4 nm to 20 nm; 4 nm to 15 nm, or even 4 nm to 10 nm).

The nanoparticle powder composition of any preceding claim, wherein the aqueous liquid having a surface tension greater than 50 dynes/cm² at 25° C. (in some embodiments, greater than 55 dynes/cm², 60 dynes/cm², 55 dynes/cm², 63 dynes/cm², 65 dynes/cm², or even greater than 70 dynes/cm² at 25° C.; in some embodiments up to 72 dynes/cm² at 25° C.; in some embodiments, in a range from 50 dynes/cm² to 72 dynes/cm², 55 dynes/cm² to 72 dynes/cm², 60 dynes/cm² to 72 dynes/cm², 63 dynes/cm² to 72 dynes/cm², or even 65 dynes/cm² to 72 dynes/cm² at 25° C.).

The nanoparticle powder composition of any preceding claim, free of a surfactant.

The nanoparticle powder composition of any of claims 1 to 9, further comprising a surfactant.

The nanoparticle powder composition of any preceding claim, wherein the nanoparticles are surface modified with a covalently bonded surface modifier.

A method of making the nanoparticle powder composition of any preceding claim, the method comprising mixing under high shear at least hydrophobic, non-aggregated nanoparticles, an aqueous liquid, and gas (e.g., including at least one of N₂, CO₂, Ar, F₂, NH₃, H₂, or He, or even air); wherein the weight ratio of the hydrophobic, non-aggregated nanoparticles to the aqueous liquid in the nanoparticle powder composition is in a range from 1:1 to 1:99 (in some embodiments, in a range from 1:1 to 2.2: 97.8, 1:1 to 4:96, 1:1 to 5:95, 1:1 to 10:90, 1:1 to 15:85, 1:1 to 20:80, or even 1:1 to 25:75) to provide the nanoparticle powder composition.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

### Preparative Example 1

Preparative Example 1, which was surface modified silica nanoparticles (SMN-A), was prepared as follows: 100 grams of silica nanoparticles (obtained under the trade designation “NALCO 2326” (16.2% solids) from Nalco, Naperville, Ill.) was placed in a 500 mL round bottom flask. The flask was placed in an oil bath equipped with a reflux condenser and a mechanical stirrer. 7.60 grams of isooctyltrimethoxysilane (obtained from Gelest Inc., Morrisville, Pa.) and 0.78 gram of methyltrimethoxysilane (obtained from Gelest Inc.) were added to the silica nanoparticles (“NALCO 2326”) along with 90 grams of ethanol (obtained from Sigma-Aldrich Chemical Company, St. Louis, Mo.) and 23 grams of methanol (obtained from Sigma-Aldrich Chemical Company). The mixture was heated to 80° C. while stirring and allowed to react at temperature for 15 hours. The sample was then dried at 150° C. in a flow through oven yielding a white powder.

### Example 1

Example 1 samples were prepared by blending 398 grams of distilled water (DI water) and 140 grams of the SMN A powder in a conventional kitchen blender on the “high” setting for about 60 seconds, wherein air was inherently blended into the mix. The resulting blend was powder. The material felt cool and was not sticky to the touch as compared to the unblended SMN-A.

When the Example 1 powder was stored in a closed plastic container did not separate out even after storage for a month.

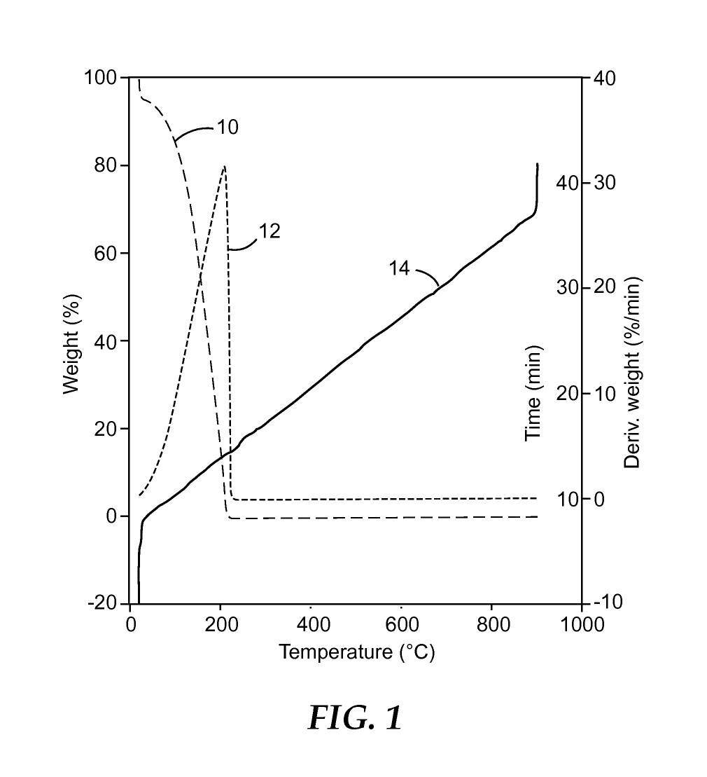

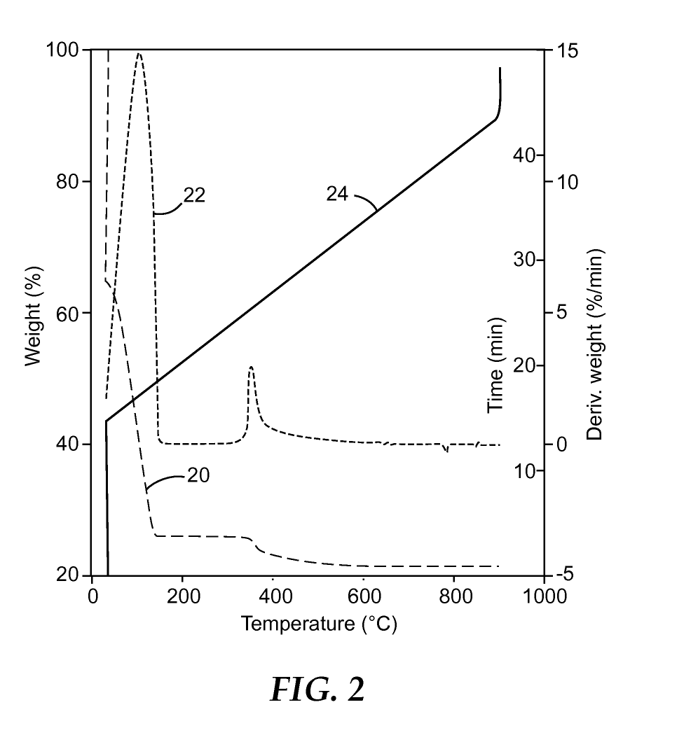

Thermogravimetric analysis (TGA) trace of deionized water and the Example 1 powder are shown in FIG. 1 and FIG. 2, respectively. Referring to FIG. 1, the TGA trace shows weight loss 10, time 12, and derivative weight loss 14 for the deionized water. Referring to FIG. 2, the TGA trace shows weight loss 20, time 22, and derivative weight loss 24 for the Example 1 powder.

### Example 2

Example 2 was prepared as described for Example 1, except 100 grams of DI water and 35 grams of SMN A powder were blended in the conventional kitchen blender on the “high” setting for 30 seconds. Example 2 powder was not visibly different from the Example 1 powder.

### Example 3-12

Examples 3-12 were prepared as described for Example 1, except the ingredients and the blending time were varied as summarized in Table 1, below. Further, Example 12 was prepared by adding an additional 1 gram of SMN-A to Example 11, followed by an additional 60 seconds of blending.

TABLE 1

| | | | Blending | |
|---|---|---|---|---|
| | | Type and | time on | |
| | Amount of | amount of other | the “high” | |
| Example | SMN-A, g | ingredient(s), g | setting, sec. | Observations |
| 3 | 20 | DI water, 180 | 60 | No liquid visible (i.e., |
| | | | | it is a powder), texture to |
| | | | | the touch is gritty, and |
| | | | | wetter than Examples 1 and 2 |
| 4 | 10 | DI water, 190 | 60 | Initially was a powder, |
| | | | | but water separated within |
| | | | | 5 minutes |
| Illustrative A | 2 | DI water, 198 | 60 | Separated in blender |
| 5 | 100 | DI water, 100 | 30 | No liquid visible, very |
| | | | | fluid powder |
| Illustrative B | 20 | glycerol, 180 | 30 | A fluid frosting |
| Illustrative C | 50 | ethylene | 30 | Fluid and shiny liquid |
| | | glycol, 150 | | |
| Illustrative D | 450 | engineering | 60 | Viscous frosting. |
| | | fluid (from 3M | | Sample dried slowly |
| | | Company, St. | | without burning the |
| | | Paul, MN, under | | nanoparticles at 150° C. |
| | | trade designation | | |
| | | “3M NOVEC | | |
| | | 7500 | | |
| | | ENGINEERED | | |
| | | FLUID”, 1050 | | |
| 6 | 20 | saturated | 60 | The material felt cool |
| | | aqueous NaCl | | and was not sticky to the |
| | | solution, 180 | | touch as compared to the |
| | | | | unblended SMN-A. |
| Illustrative E | 4.4 | saturated | 60 | Liquid in the blender |
| | | aqueous NaCl | | |
| | | solution, 195.6 | | |
| 7 | 5.4 | saturated | 120 | The material felt cool |
| | | aqueous NaCl | | and was not sticky to the |
| | | solution, 195.6 | | touch as compared to the |
| | | | | unblended SMN-A. |
| 8 | 10 | aqueous solution | 60 | Powder |
| | | (2.5 wt. %) of | | |
| | | NiCl₂•6H₂O, 190 | | |

### Example 8

Example 8 was prepared as described for Example 1, except 190 grams of an aqueous solution (2.5 wt. %) of NiCl₂.6H₂O and 10 grams of SMN-A were blended in the conventional kitchen blender on the “high” setting for 60 seconds, wherein air was inherently blended into the mix. The blended product had a greenish color, but the texture felt the same as Example 1 without NiCl₂.6H₂O. When an additional 25 grams of SMN-A was added and mixed in the conventional kitchen blender on the “high” setting for an additional 60 seconds. The resulting product was very dry (˜84% water) and powdery to the touch.

2 mL of the resulting mixture was placed in a syringe equipped with a 0.45 micrometer syringe filter (obtained under the trade designation “PTFE ACRODISC” from VWR International, Radnor, Pa.). When the syringe was engaged, the water (which was green) easily separated out.

### Preparative Example 2

Preparative Example 2, which was surface modified silica nanoparticle powder (SMN-B), was prepared as described for Preparative Example 1 except as follows: 600 grams of silica nanoparticles (“NALCO 2326”) was placed in a 2 L round bottom flask. The flask was placed in an oil bath and was equipped with a reflux condenser and a mechanical stirrer. 26.66 grams of isooctyltrimethoxysilane (obtained from Gelest Inc.) and 22.59 grams phenyltrimethoxysilane (obtained from Gelest Inc.) were added to the silica nanoparticles (“NALCO 2326”) along with 540 grams of ethanol (Sigma-Aldrich Chemical Company) and 135 grams of methanol (Sigma-Aldrich Chemical Company).

### Preparative Example 3

Preparative Example 3, which was surface modified silica nanoparticles (SMN-C), was prepared as described for Preparative Example 1, except as follows: 6 00 grams of silica nanoparticles (“NALCO 2326”) was placed in a 2 L round bottom flask. The flask was placed in an oil bath and was equipped with a reflux condenser and a mechanical stirrer. 39.53 grams of isooctyltrimethoxysilane (from Gelest Inc.) were added to the silica nanoparticles (“NALCO 2326”) along with 675 grams of 1-methoxy-2-propanol (obtained from Sigma-Aldrich Chemical Company).

### Illustrative Example F

Illustrative Example F was prepared in the same manner as Example 1, except 150.12 grams of DI water and 50.07 grams of SMN-B were blended in the conventional kitchen blender on the “high” setting for 60 seconds, wherein air was inherently blended into the mix. The resulting material separated immediately.

### Example 9

Example 9 was prepared as described for Example 1, except 150.08 grams of DI water and 50.11 grams of SMN-C were blended in the conventional kitchen blender on the “high” setting for 60 seconds, wherein air was inherently blended into the mix. The resulting material remained as a powder, but was gritty and felt very wet to the touch.

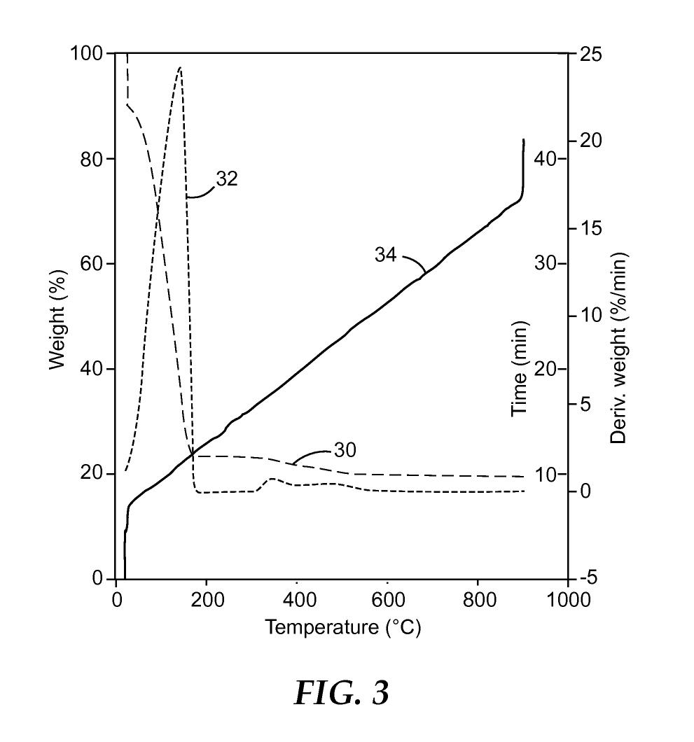

Thermogravimetric analysis (TGA) trace of the Example 9 powder is shown in FIG. 3. Referring to FIG. 3, the TGA trace shows weight loss 30, time 32, and derivative weight loss 34 for the Example 9 powder.

### Preparative Example 4

Preparative Example 4, which was surface modified silica nanoparticle (SMN-D), was prepared by combining 1500 grams of silica nanoparticles (“NALCO 2326”) with 152.2 grams of Al230 (an ethoxylated silane available from Momentive Performance Materials, Albany, N.Y.)) that were placed in a 2 L round bottom flask. The flask was placed in an oil bath and was equipped with a reflux condenser and a mechanical stirrer. The mixture was heated to 80° C. with stirring and allowed to react overnight (˜15 hours).

### Example 10

Example 10 was prepared as described for Example 1, except 142.5 grams of DI water, 7.5 grams of SMN-D, and 50 grams of SMN-A were blended in the conventional kitchen blender on the “high” setting for 60 seconds, wherein air was inherently blended into the mix. The resulting material initially behaved similar to Example 1, but after about 15 seconds, the material became more like frosting, yet flowable. Further mixing continued to make material feel wetter to the touch.

### Example 11

Example 11 was prepared as described for Example 16, except 142.5 grams of DI water, 7.5 grams of SMN-D, and 50 grams of SMN-A were blended in the conventional kitchen blender on the “high” setting for 10 seconds, wherein air was inherently blended into the mix. The resulting material was a very wet feeling powder to the touch, but behaved more like a powder than the Example 16 material.

Foreseeable modifications and alterations of this disclosure will be apparent to those skilled in the art without departing from the scope and spirit of this invention. This invention should not be restricted to the embodiments that are set forth in this application for illustrative purposes.

1. A nanoparticle powder composition comprising hydrophobic, non-aggregated nanoparticles, an aqueous liquid, and gas, wherein the weight ratio of the hydrophobic, non-aggregated nanoparticles to the aqueous liquid in the nanoparticle powder composition is in a range from 1:1 to 1:99.

2. The nanoparticle powder composition of claim 1, wherein the weight ratio of the hydrophobic, non-aggregated nanoparticles to the aqueous liquid in the nanoparticle powder composition is in a range from 1:1 to 2.2: 97.8.

3. The nanoparticle powder composition of claim 1, wherein the weight ratio of the hydrophobic, non-aggregated nanoparticles to the aqueous liquid in the nanoparticle powder composition is in a range from 1:1 to 5:95.

4. The nanoparticle powder composition of claim 1, wherein the aqueous liquid consists of water.

5. The nanoparticle powder composition of claim 1, wherein the aqueous liquid comprises water and at least organic liquid.

6. The nanoparticle powder composition of claim 5, wherein the organic liquid is present in a range from greater than zero to 10 percent by weight, based on the total weight of the aqueous liquid.

7. The nanoparticle powder composition of claim 1, wherein the gas is air.

8. The nanoparticle powder composition of claim 1, wherein the nanoparticles comprise at least one of ceramic or metal.

9. The nanoparticle powder composition of claim 1, wherein the nanoparticles comprise at least one of SiO₂, TiO₂, MgO, Al₂O₃, Fe₂O₃, ZnO, ZrO₂, rare earth oxide, CaCo3, Ag, Al, or Ag.

10. The nanoparticle powder composition of claim 1, wherein the nanoparticles are surface modified with a covalently bonded surface modifier.

11. The nanoparticle powder composition of claim 1, wherein the nanoparticles have a primary particle size of not greater than 20 nm.

12. The nanoparticle powder composition of claim 1, wherein the aqueous liquid having a surface tension greater than 50 dynes/cm² at 25° C.

13. The nanoparticle powder composition of claim 1, free of a surfactant.

14. The nanoparticle powder composition of claim 1, wherein the nanoparticles are surface modified with a covalently bonded surface modified.

15. A method of making the nanoparticle powder composition of claim 1, the method comprising mixing under high shear at least hydrophobic, non-aggregated nanoparticles, an aqueous liquid, and gas, wherein the weight ratio of the hydrophobic, non-aggregated nanoparticles to the aqueous liquid in the nanoparticle powder composition is in a range from 1:1 to 1:99 to provide the nanoparticle powder composition.
